(19) United States
(12) Patent Application Publication
(10) Pub. No.: US 2012/0247019 A1
(43) Pub. Date: Oct. 4, 2012

(54) DRIVE APPARATUS FOR BOARDING/DEBOARDING DEVICES

(75) Inventor: Nils GIBHARDT, Gudensberg (DE)

(73) Assignee: GEBR. BODE GMBH & CO. KG, Kassel (DE)

(21) Appl. No.: 13/299,540

(22) Filed: Nov. 18, 2011

(30) Foreign Application Priority Data
Mar. 28, 2011 (DE) 20 2011 004 485.8

(51) Int. Cl. B60J 5/04

(52) U.S. Cl. 49/324

(57) ABSTRACT

A drive device for boarding/deboarding devices, in particular inward-swinging doors, for public transport vehicles is described, comprising a drive unit, which is disposed in a rotation post and drives it for opening and closing the boarding/deboarding device, wherein the drive unit is supported by a supporting component on the vehicle and the supporting component acts as a counter bearing for a torque of the drive unit, and with at least two supporting arms connected to the rotation post for supporting the boarding/deboarding device, wherein at least one supporting arm has an extension component parallel to the rotation post.

### CROSS REFERENCE TO RELATED APPLICATION

This patent application claims priority to co-pending German Utility Model No 20 2011 004 485.8 which was filed on Mar. 28, 2011 and which is hereby expressly incorporated by reference in its entity as part of the present disclosure.

### TECHNICAL FIELD

The present invention relates to a drive device for boarding/deboarding devices, in particular inward-swinging doors, for public transport vehicles.

Such drive devices for inward-swinging doors, outward-swinging doors or pivot sliding doors with one or several door leaves for public transport vehicles are known per se in various configurations.

Conventional drive devices are generally based upon a rectangular shape of the door opening. However, there are boarding/deboarding devices for public transport vehicles that have a constructional shape that deviates from this rectangular shape of a door opening. For example, buses are known which have in the area of the front section, in particular in area of the ceiling of the front section, a curvature of the ceiling. This particular configuration of the front section limits the available construction space for mounting the boarding/deboarding device adjacent to this front section to such a degree that at least one edge of the door opening, for example the front edge, must be adapted to the curvature of the vehicle's front section, that is, is also curved.

### BRIEF DESCRIPTION OF RELATED ART

For example, WO 2009/055107 A1 discloses a drive device for an inward-swinging door for a bus or a rail-operated vehicle, wherein the vehicle has a curvature of the front section as described above. A drive shaft, which is respectively disposed along the outer edge of the pivoting door and is connected with the respective door leaf via straight supporting arms extending perpendicularly to the drive shaft, is allocated to each door leaf of the above described double-leaf inward-swinging door, so that the door leaf, upon the drive shaft being rotated, is pivoted by it into an opened or closed position into the interior of the vehicle. The drive shafts themselves are connected at their upper ends with a door operating mechanism and are driven, i.e. rotated, by it, wherein the door operating mechanism is accommodated above the inward-swinging door in a construction space provided therefor.

The door frame accommodating the front door leaf as well as the front door leaf itself have a curvature adapted to the curved front section of the vehicle, in particular at the respective front edge. Accordingly, the upper edge of the door leaf is shorter than the lower edge. Due to the very limited construction space in the area of the door operating mechanism, the latter substantially does not extend beyond the upper edge of the door leaf, so that the front drive shaft is divided into an upper and a lower part which are disposed offset to each other in the longitudinal direction of the vehicle in such a way that the upper part of the drive shaft extends along the upper part of the front edge of the door leaf and the lower part of the drive shaft extends along the lower part of the front edge of the door leaf. The upper part of the drive shaft and the lower part of the drive shaft are interconnected through a flexible intermediate shaft for transmitting a torque from the upper onto the lower drive shaft.

What is disadvantageous is the comparatively large space requirement for this drive device, in particular for the door operating mechanism disposed above the boarding/deboarding device. Moreover, the installation and adjustment of such a drive device is relatively time-consuming. Moreover, by dividing the drive shaft into an upper and a lower partial shaft and due to the intermediate shaft, which has to be connected with these partial shafts and which, in turn, has to be guided in an outer sleeve and suitably lubricated, the number of installation and maintenance steps increases considerably. Due to their structure, which generally consists of several layers of wires wound around one another in a helical form, flexible shafts furthermore have a preferred direction of rotation so that the power that can be transmitted by the shaft is dependent upon the direction of rotation.

### BRIEF SUMMARY OF THE INVENTION

It is against this background that the invention proposes a drive device for boarding/deboarding devices, in particular inward-swinging doors, for public transport vehicles which has as compact and space-saving a constructional design as possible. Production and installation are supposed to be possible in a simple and cost-effective manner. Moreover, the drive device is to be as robust and rugged as possible and constructed from as few components as possible.

The invention, in one embodiment, provides a drive device for boarding/deboarding device, in particular inward-swinging doors, for public transport vehicles.

It must be remarked that the features described and claimed herein can be combined with each other in any technologically meaningful manner and represent other embodiments of the invention. The description, in particular in connection with the figures, additionally characterizes and specifies the invention.

According to the invention, a drive device for boarding/deboarding devices, in particular inward-swinging doors, for public transport vehicles comprises a drive unit, which is disposed in a rotation post and drives it for opening and closing the boarding/deboarding device, wherein the drive unit is supported by a supporting component on the vehicle and the supporting component acts as a counter bearing for a torque of the drive unit. Furthermore, the drive device comprises at least two supporting arms connected to the rotation post for supporting the boarding/deboarding device, wherein at least one supporting arm has an extension component parallel to the rotation post.

Within the sense of the present invention, rotation post is supposed to mean the part, in particular the cylindrical or tubular part, of the drive device according to the invention which is rotated about an axis of rotation by the drive device for opening and closing the boarding/deboarding device, for example an inward-swinging door.

Extension components of the supporting arm in the sense of the invention are supposed to mean those components that are obtained when the extension vector in the longitudinal direction of the supporting arm is divided into a component parallel to the rotation post and one component (2D) or several components (3D) perpendicular to the rotation post. If, for example a z-coordinate axis of a three-dimensional orthogonal coordinate system is oriented parallel to the rotation axis of the rotation post, and if thus an x and y-coordinate axis are respectively oriented perpendicular to the rotation axis, then the z-component of the extension vector in the longitudinal direction of the supporting arm is, according to the present invention, an extension component parallel to the rotation post in this coordinate system.

Due to the fact that at least one supporting arm of the drive device according to the invention has an extension component parallel to the rotation post, the position of the support or bearing points of the boarding/deboarding device, in particular of an inward-swinging door, supported by the supporting arms is independent from the length of the rotation post itself. In the hitherto known drive devices of the type mentioned in the introduction, the supporting arms connected with a drive shaft extend perpendicularly and straight relative to the drive shaft. In these conventional drive devices, the connection of such supporting arms for instance to an upper or lower edge of the door causes the drive shaft to have at least the same height as the door to be driven, generally even a greater height.

With the drive device according to the invention, it is now possible to drive doors that are larger than the height or length of the rotation post. This is advantageous in particular in cases in which, for example due to a particular constructional shape of the vehicle, the construction space available for installing the drive device in the vehicle is limited to such an extent that only a rotation post can be used that has a height or length which is less in comparison to the door to be driven.

Furthermore, the inventive arrangement of the drive unit directly in the rotation post with which the boarding/deboarding device, in particular a door or inward-swinging door, is moved, offers the important advantage that the construction space above the boarding/deboarding device is not required anymore, for example, for a door operating mechanism, but can either be used for other devices or can be completely dispensed with. What is important in such an arrangement, however, is also the fact that a counter-bearing is put up against the torque raised by the drive device. Therefore, the drive unit is attached to a fixed component of the vehicle. It is thus possible that the output torque of the drive device can be transmitted onto the rotation post and that the latter rotates.

Accommodating the drive unit directly in the rotation post, apart from saving space, also has many advantages with regard to maintenance and installation of the entire drive device.

Another advantageous embodiment of the invention provides that the supporting arm whose one extension component is oriented parallel to the rotation post moreover has at least one crank in the area of the distal end. The respective crank can in this case be formed both in an arcuate manner as well as from several straight portions, wherein, in the latter case, respectively adjacent portions are interconnected at an angle of less than 180°. The crank provided in the distal end portion of the supporting arm according to the invention whose one extension component is oriented parallel to the rotation post on the one hand makes it possible to provide a rotation axis of the door leaf supported by the supporting arms which is substantially vertical, that is, substantially parallel to the rotation post. On the other hand, an even better utilization of space can thus be achieved as well, because the rotation post can be placed closer to the boarding/deboarding device, that is, at an edge of the door to be driven. Moreover, the crank of the supporting arm offers more room for the rotary movement of the boarding/deboarding device, in particular in the case of an inward swinging door, which rotates below an upper supporting arm or above a lower supporting arm. Thus, the shape of the boarding/deboarding device, in particular the shape or extent of the door edge facing the rotation post, is not additionally unnecessarily limited by the supporting arm, but is merely determined by the available construction space of the vehicle. Advantageously, the door can be provided with a larger window area if a supporting arm with a crank is used, which improves the view for a driver of the vehicle.

In another advantageous embodiment of the invention the drive device is formed exclusively of substantially rigid components. The term “rigid” within the sense of the present invention is to be construed to mean that no flexible, for example bendable, components have to be used for the assembly of the drive device according to the invention and of course includes a certain elasticity of the components as it is naturally inherent in the substantially rigid components. The drive device according to the invention formed from the rigid components is advantageously characterized by a particularly good stability. Due to the capacity of the rigid components to be able to absorb forces substantially from all directions and transmit them, extremely few, for example, merely two, bearing locations are required for attaching the drive device in and on the vehicle for a safe and reliable operation of the drive device according to the invention.

With another advantageous embodiment of the invention in which the rotation post of the drive device is configured straight, the construction space occupied by the drive device can be reduced even more. The stability of the rotation post and thus, the stability of the entire drive device, is increased even more due to the straight configuration, because the forces acting on the bearing locations of the rotation post are absorbed and transmitted only via a straight, tubular or cylindrical component (rotation post).

Advantageously, a support of the drive device or drive unit is provided which takes into account that, due to the length of the rotation post, distortion and deflection of the same during operation can hardly be avoided. The movements of the rotation post are caused, for example, by the vehicle being compressed or twisted due to acceleration and braking processes as well as cornering. In the case of buses, the contact of tires with curbstones and similar edges leads to a deformation of the vehicle and thus, to a movement of the rotation post. Since the drive unit is fixed to a stationary component, such distortions and deflections of the rotation post can have a negative effect on the drive device. For this reason, the drive unit is connected to the supporting component via a bearing that enables the rotation post to tumble but prevents a rotation about the axis of rotation of the rotation post. Tumbling refers to a deflection of the rotation post perpendicular to its rotation axis. This function compensates, so to speak, a relative movement between the drive unit and the post.

Advantageously, a movement in the direction of the axis of rotation of the rotation post is still possible. For this purpose, a guide shaft connecting the drive unit with the bearing is slidably mounted in a guide of the bearing. For transmitting the torque, the guide shaft is preferably non-circular; it can have, for example, a multi-edged or polygonal geometry.

The rotation post itself is rotatably mounted, preferably also in the same supporting component which also supports the drive unit. By using a conventional joint bearing for bearing the rotation post, the latter is able to rotate in the supporting component and at the same time can compensate deviations of position between the upper and the lower bearing in the direction perpendicular to the rotation axis of the rotation post. The pivot point of the guide shaft and the rotation post bearing should in this case lie in a single plane, that is, be disposed in approximately the same position of the axis of rotation. This prevents strains and loads on the bearings and causes the movement of the drive unit and the rotation post to run as parallel as possible.

The mobile and flexible support of the drive device or the drive unit permits fitting the drive device into different vehicles, in particular also in such vehicles in which the construction space available for the installation of the drive device is subject to strong limitations due to the design of the vehicle. It is even conceivable to use the drive device in a rotation post with a little inclination, for example a slant of up to 5°. In addition, the moveable support helps compensating fitting tolerances, which facilitates the installation and maintenance of the entire drive device.

A ball shaft joint bearing has proved to be a particularly suitable bearing. The guide shaft is guided in a ball receptacle by means of balls. Ball-shaped depressions that keep the balls in position are disposed in the guide shaft. Corresponding elongated depressions in which the balls are guided are provided in the ball receptacle parallel to the rotation axis of the rotation post. The position of the elongated guides in the direction of the rotation axis prevents the rotary movement about the rotation axis but at the same time enables a tumbling movement about the rotation axis. Preferably, the ball receptacle can be configured in two parts.

The guide shaft can preferably have a continuous bore extending along its longitudinal axis, through which the necessary cables and similar connections can be routed. Such a bore is advantageous in that, on the one hand, space utilization is optimized, and on the other hand, the cables and connections routed therein are protected.

### BRIEF DESCRIPTION OF DRAWINGS

Other advantageous details and effects of the invention are explained in more detail below with reference to two exemplary embodiments illustrated in the Figures. In the figures:

FIG. 1 shows a schematic side view of a first exemplary embodiment of a drive device according to the invention,

FIG. 2 shows a sectional view for explaining the support of the drive device from FIG. 1,

FIG. 3 shows a cross-sectional view through the bearing shown in FIG. 2,

FIG. 4 shows a perspective view of a second embodiment of the drive device according to the invention, built into a public transport vehicle,

FIG. 5 shows an enlarged perspective view of an upper area of the drive device shown in FIG. 4,

FIG. 6 shows an enlarged perspective view of the upper area from FIG. 5 viewed obliquely from below,

FIG. 7 shows a perspective view of a lower area of the drive device shown in FIG. 4 inside a vehicle, and

FIG. 8 shows a perspective view of the lower area shown in FIG. 7 outside the vehicle.

In the different figures, the same parts are always provided with the same reference numerals so that they are also only described once, as a rule.

### DETAILED DESCRIPTION

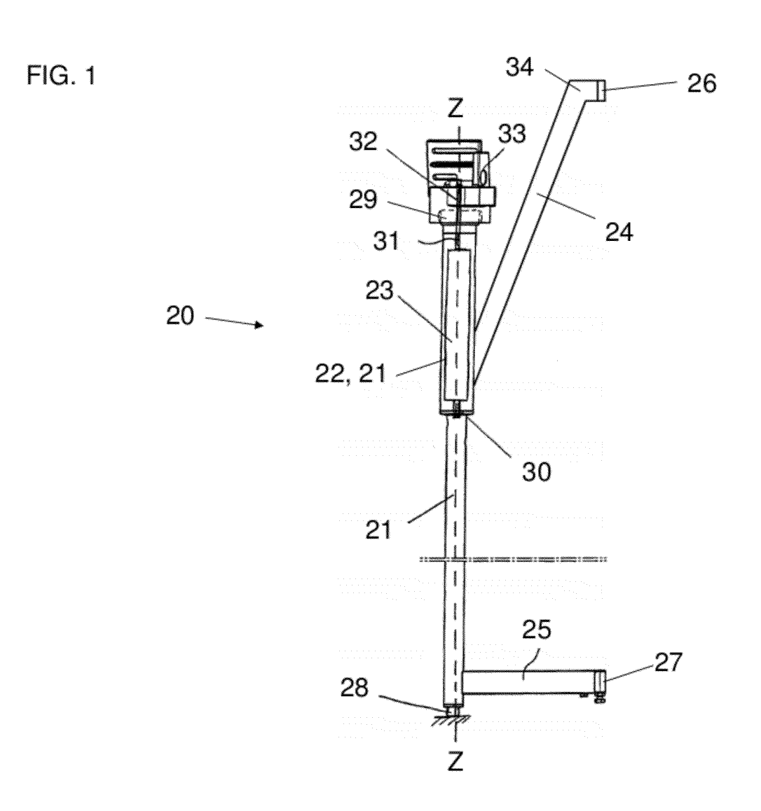

FIG. 1 shows a simplified, schematic side view of a first exemplary embodiment of a drive device 20 according to the invention. The drive device 20 comprises a substantially cylindrical or tubular slim rotation post 21. A drive unit 23, for example an electric motor, is disposed in one area 22 of the rotation post 21. As can be seen in FIG. 1, the area 22 for accommodating the drive unit 23 has a slightly larger diameter as compared with the rest of the rotation post 21 but otherwise does not differ substantially from the rest of the rotation post 21. Therefore, the area 22 shall be included where reference is made to the rotation post 21 in the explanations below unless otherwise stated.

The drive unit 23 drives the rotation post 21 for opening and closing a boarding/deboarding device, for example a door which is not shown in FIG. 1. For supporting the door, the rotation post 21 shown in FIG. 1 comprises two supporting arms, in particular an upper supporting arm 24 and a lower supporting arm 25, which are respectively connected with their proximal ends to the rotation post 21. At their distal ends, the upper and the lower supporting arms 24 and 25, respectively, have a bearing 26 and 27, respectively, by means of which the door is rotatably supported by the drive device 20 according to the invention between the supporting arms 24 and 25.

The rotation post 21 itself is supported on an underlying surface, usually a vehicle floor, via a rotary floor bearing. Moreover, a rotary bearing 29 is shown in the exemplary embodiment of the drive device 20 depicted in FIG. 1, through which the rotation post 21 is supported rotatably about a longitudinal or rotation axis Z-Z.

The drive unit 23 is non-rotatably connected with the rotation post 21 via a rotation post bearing 30, so that a rotary movement of the rotation post 21 can be effected via the rotation post bearing 30. A guide shaft 31 extends into the bearing 29 from within the drive unit 23. The guide shaft 31 is non-rotatably connected with the latter via a drive unit bearing 32 (bearing of the drive unit 23). The drive unit bearing 32 can, for example, be configured as a ball shaft joint bearing and serves for receiving or as a counter-bearing for the torque of the drive unit 23, wherein the drive unit bearing 32 in turn is solidly connected to a supporting component 33 with which the drive unit 23 is supported on the vehicle.

As can further be seen from FIG. 1, the supporting arm 24 has an extension component parallel to the rotation post 21, that is, in the direction of the rotation axis Z-Z. In contrast thereto, the lower supporting arm 25 extends substantially perpendicularly to the rotation post 21 in the exemplary embodiment shown.

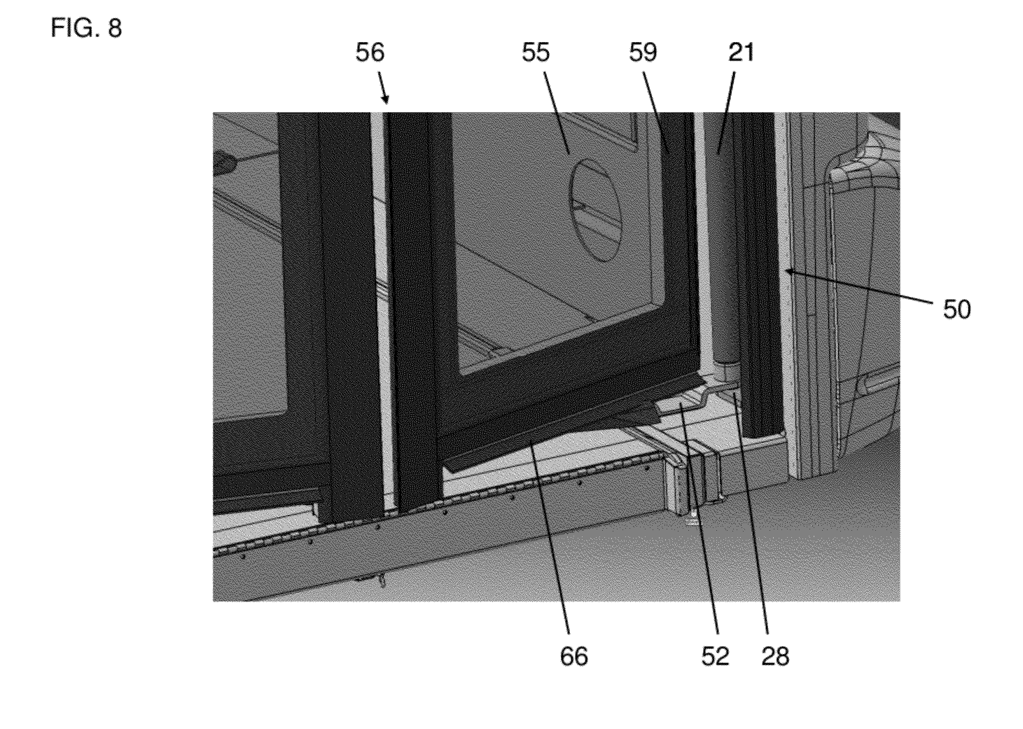

Due to the fact that at least one of the supporting arms 24, 25 of the drive device 20 according to the invention has an extension component parallel to the rotation post 21, the position of the support or bearing points of the boarding/deboarding device, in particular of an inward-swinging door, supported by the supporting arms 24, 25, and thus the position of the bearings 26 and 27, is independent from the length of the rotation post 21. Thus, with the drive device 20 according to the invention, it is possible to drive boarding/deboarding devices or doors that are larger than the height or length of the rotation post 21. In FIG. 1 this is illustrated by a schematically indicated door leaf 55. The door leaf 55—including a lower sealing device 66 which will be discussed in more detail below in connection with the description of FIG. 8—can be larger than the rotation post 21. In particular, as can be seen from FIG. 1, the upper rotary bearing 29 of the rotation post 21 can lie below the upper edge of the door leaf 55 or below the upper door bearing 26.

A great advantage of the drive device 20 according to the invention lies in the fact that a rotation post 21 with a height or length that is smaller as compared to the boarding/deboarding device to be driven can be used even if the construction space available in the vehicle for the installation of the drive device 20 is limited, for example due to the particular constructional shape of the vehicle, and if thus the use of conventional drive devices is not possible anymore.

As can also be seen in FIG. 1, the supporting arm 24, which has an extension component parallel to the rotation post 21, furthermore has a crank 34 in the area of the distal end. In the exemplary embodiment shown, the crank is formed from two adjacent straight portions that are interconnected at an angle of less than 180°, for example by welding, gluing, riveting, screwing or the like. The crank 34 enables an even better utilization of space because the rotation post 21 can be placed even closer to the boarding/deboarding device, that is, at an edge of the door to be driven. Moreover, the crank 34 of the supporting arm 24 offers more room for the rotary movement of the boarding/deboarding device, in particular in the case of an inward swinging door, which rotates below an upper supporting arm 24 or above the lower supporting arm 25. Thus, the shape of the boarding/deboarding device, in particular the shape or extent of the door edge facing the rotation post 21, is not additionally unnecessarily limited by the supporting arm 24, 25, but is, for example, determined only by the available construction space of the vehicle. It is thus possible, for example, to provide the boarding/deboarding device with as large a window as possible so that a better view through the boarding/deboarding device is offered to a driver of the vehicle by means of the drive device according to the invention.

The drive device 20 shown in FIG. 1 is formed only of substantially rigid components, that is, the rotation post 21, the drive unit 23, the supporting arms 24 and 25 as well as the supporting component 33 are rigid components. As was already explained above, the term “rigid” of course includes a certain natural elasticity of the components and excludes such components that have an intended larger flexibility exceeding this natural elasticity. The drive device 20 according to the invention formed from the rigid components is characterized by a particularly good stability. Due to the capacity of the rigid components to be able to absorb forces substantially from all directions and transmit them, the drive device 20 can be attached in and on the vehicle for a safe and reliable operation with only two bearing locations, i.e. a single supporting component 33 and a single floor bearing 28. This simplifies both the installation as well as the adjustment of the drive device 20 according to the invention considerably.

As can also be seen from FIG. 1, the rotation post 21 of the drive device 20 is configured straight. The construction space occupied and required by the drive device 20 can thus be reduced even more. All forces that are absorbed, for example, via the supporting arms 24 and 25 are absorbed only by a single rugged, straight component, namely the rotation post 21, and introduced, via the bearing locations of the rotation post 21, into the vehicle structure, which further increases the stability of the entire drive device 20.

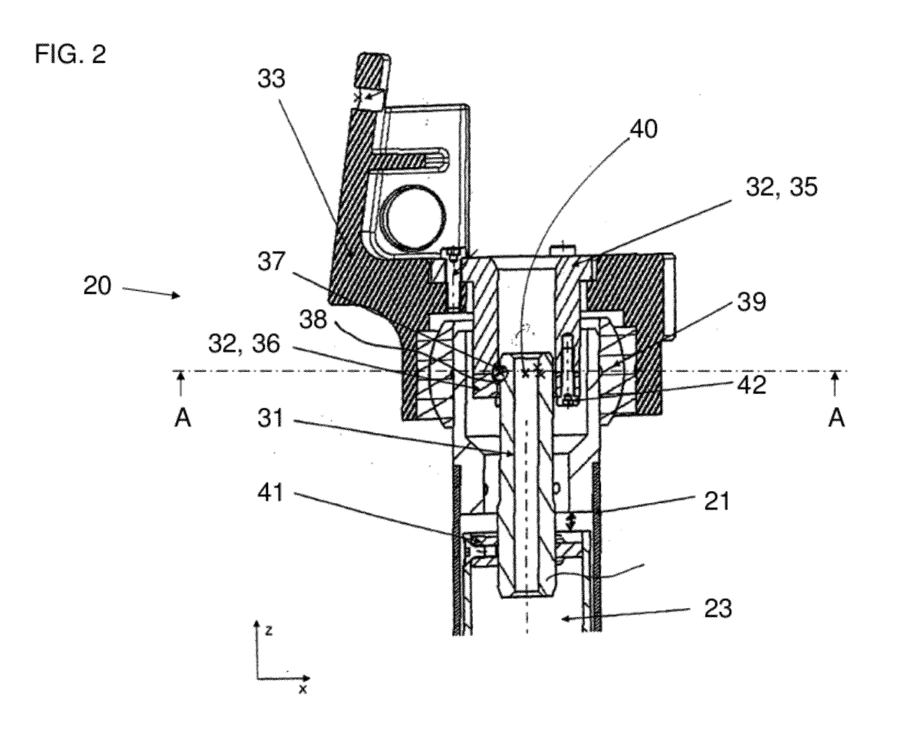

FIG. 2 illustrates the support according to the invention of the drive device 20 from FIG. 1. The supporting component 33 serves as a support for the torque of the drive unit 23. The bearing 32 is configured as a ball shaft joint bearing, and the guide shaft 31 is guided in a two-part ball receptacle 35, 36 by means of balls 37. The guide shaft 31 comprises ball-shaped receptacles for the balls 37 which keep them in position. Corresponding elongated depressions 38 are provided in the two-part ball receptacle 35, 36, which extend in the Z-direction, that is, parallel to the rotation axis of the rotation post 21. Because of these guides, the guide shaft 31 is capable of executing tumbling movements. On the one hand, the depressions 38 allow the guide shaft 31 to tumble in the Z-direction, and on the other hand, they allow the torque to be transmitted about the longitudinal or rotation axis Z-Z.

The rotation post 21 is supported via the joint bearing 39, in which the rotation post 21 is able to rotate about the rotation axis Z-Z and compensate tumbling movements. In order for the tumbling movement of the rotation post 21 and of the drive device 23 to be able to run parallel to each other, the ball receptacle 35, 36 or the balls 37 retained thereby, are disposed centrally in the Z-direction in the joint bearing 39. The rotation post 21 and the guide shaft 31 thus have a joint tumbling point 40, so to speak, which is disposed on the longitudinal or rotation axis Z-Z. In order to permit the drive unit 23 to slide in the Z-direction during tumbling, the guide shaft 31 is provided with a multi-edged geometry that can glide slidably in the Z-direction in a guide 41 and transmit the torque of the drive unit 23.

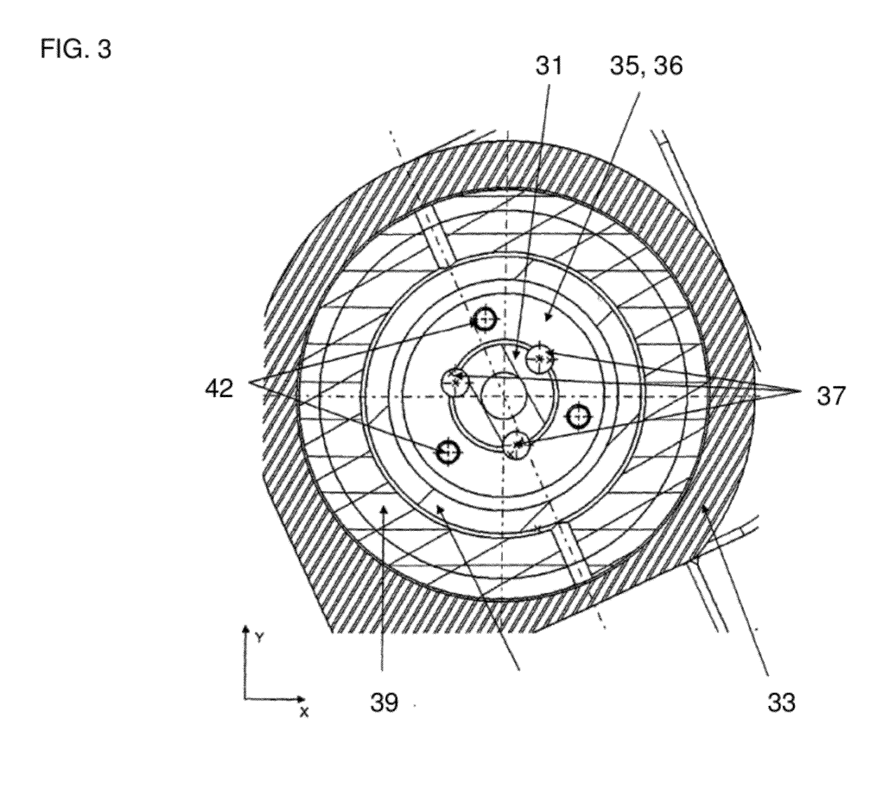

FIG. 3 shows a cross section through the bearing 32 along the line of cut A-A shown in FIG. 2 and illustrates the arrangement of the balls 37. Screws 42, which connect the two ball receptacles 35 and 36 to each other, are visible.

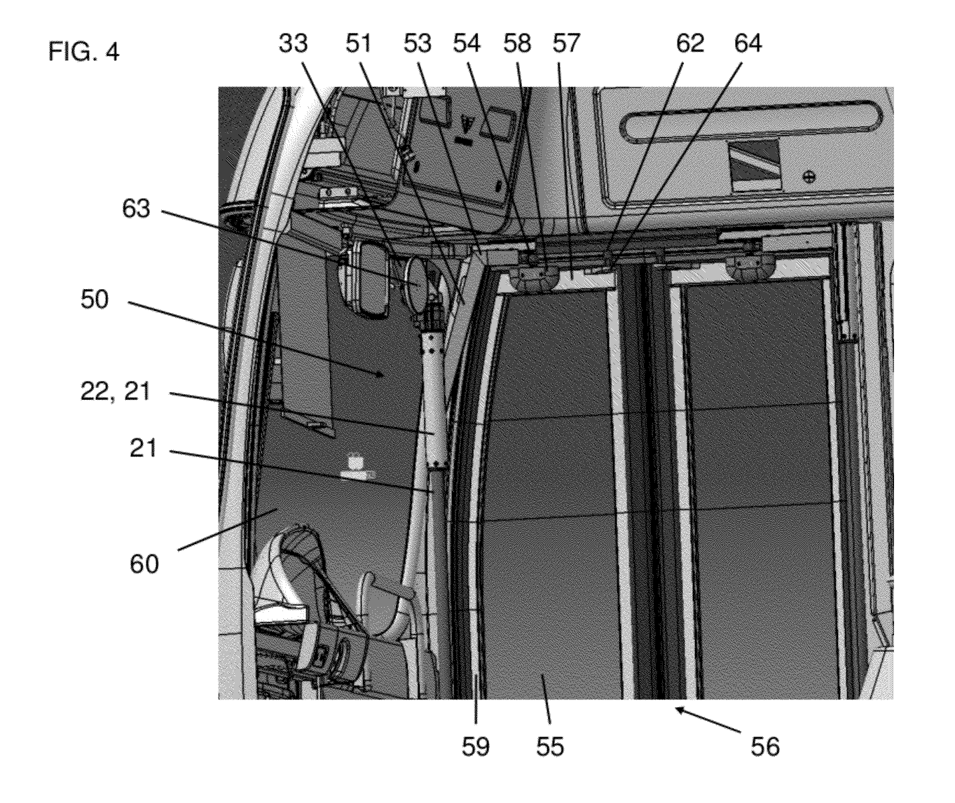

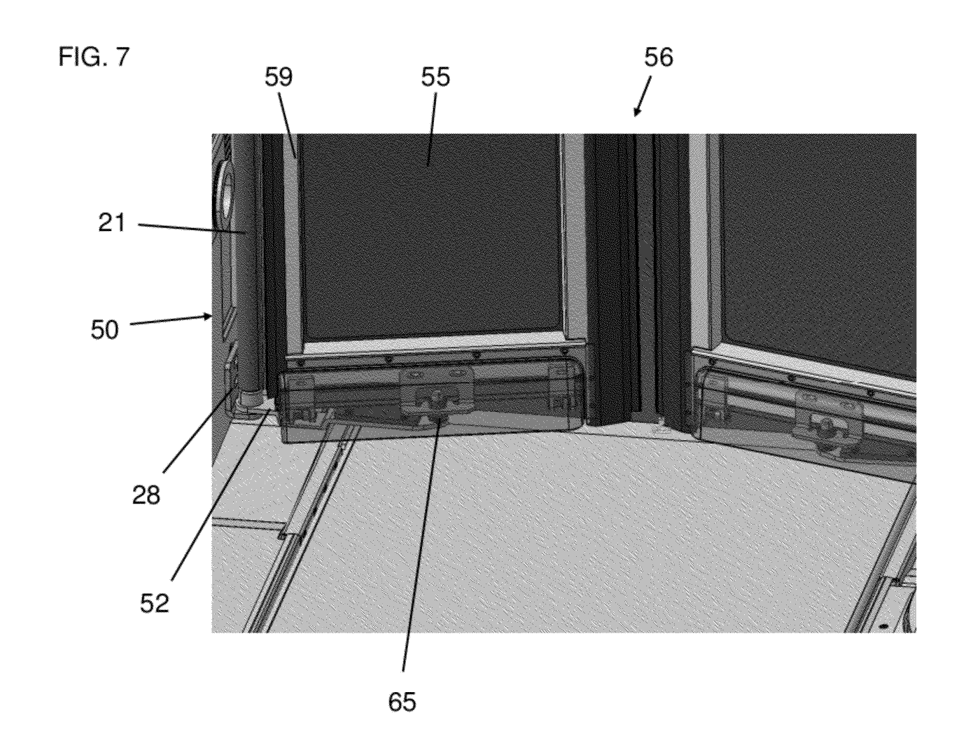

FIG. 4 shows a perspective view of a second embodiment of the drive device 50 according to the invention, shown installed in a public transport vehicle, in particular a bus. Substantially, the drive device 50 shown in this illustration differs from the drive device 20 shown in the previous Figures only in the particular configuration of the upper and lower supporting arms 51 and 52. The lower supporting arm 52 of the drive device 50 can be seen in the FIGS. 7 and 8 explained below.

As can be seen in FIG. 4, the crank 53 of the supporting arm 51 is formed from three straight portions, wherein the adjacent portions are respectively interconnected at an angle of less than 180°. At its distal end, the supporting arm 51 comprises a rotary bearing 54 on which a door leaf 55 of an inward-swinging door 56 is rotatably mounted as a boarding/deboarding device. In particular, the door leaf 55 is rotatably connected to the supporting arm 51 or the bearing 54 through a door bearing 58 attached to the upper door edge 57.

As can be seen from FIG. 4, the front door edge 59 of the inward-swinging door 56 is adapted to a curvature of the vehicle front section, that is, is also curved, in particular in an area adjacent to the front windscreen 60 of the vehicle.

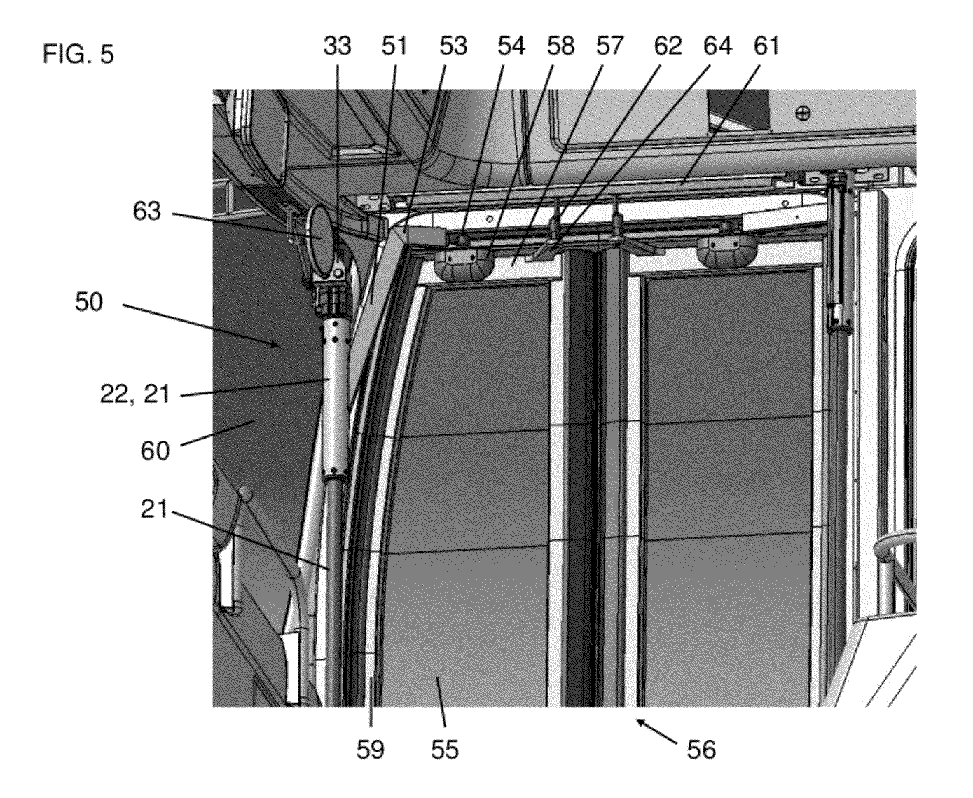

In FIG. 4 the inward-swinging door 56 is shown in a closed position. When the inward-swinging door 56 is opened, that is, when the drive device 50 or the rotation post 21 is rotated by the drive unit 23 accommodated therein, the supporting arm 51 pulls the door leaf 55 inwards so that the front edge 59 of the door leaf 55 swings inwards. In the process the entire door leaf 55 swings through under the supporting arm 51 about a rotation axis determined by a bearing pin 62 of the door leaf 55. The bearing pin 62 is accommodated so as to be laterally displaceable in a guide rail 61 extending above the inward-swinging door 56 (see FIG. 5). The crank 53 of the supporting arm 51, in a particularly advantageous manner, makes a window surface of the door leaf 55 possible that is as large as possible and furthermore allows the rotation post 21 to be disposed as closely as possible to the door edge 59 for a space-saving installation.

As can further be seen from FIG. 4, the rotation post 21 is connected to the vehicle via the supporting component 33 above the windscreen 60. In the vehicle structure shown in FIG. 4, the limited construction space available for the installation of the drive device 50 becomes particularly clear. There is no further space available for accommodating the drive device 50 or parts thereof both above the inward-swinging door 56 as well as above the windscreen 60. Thus, the compact drive device 50 according to the invention offers the great advantage that the inward-swinging door 56 or the door leaf 55 can be driven, that is, opened and closed, with a rotation post 21 which is smaller than the height of the door leaf 55. This is accomplished by the supporting arm 51 having an extension component parallel to the rotation post 21. Since the drive unit 23 is already disposed in the rotation post 21 itself, the door operating mechanism which is attached above the boarding/deboarding device and is required in drive devices according to the prior art can also be omitted.

FIG. 5 shows an enlarged perspective view of an upper area of the drive device 50 shown in FIG. 4. As can be seen, the supporting component 33 in the exemplary embodiment shown is attached to the vehicle in a particularly space-saving manner, directly adjacent to the rearview mirror 63. The guide rail 61 which is disposed above the inward-swinging door 56 and in which the bearing pin 62 is accommodated so as to be laterally displaceable can also be seen clearly in FIG. 5. The bearing pin 62 forms the rotation axis of the door leaf 55 about which the latter rotates during opening and closing processes. The bearing pin 62 is rotatably supported in a bearing pin bracket 64 appropriately connected to the door leaf 55.

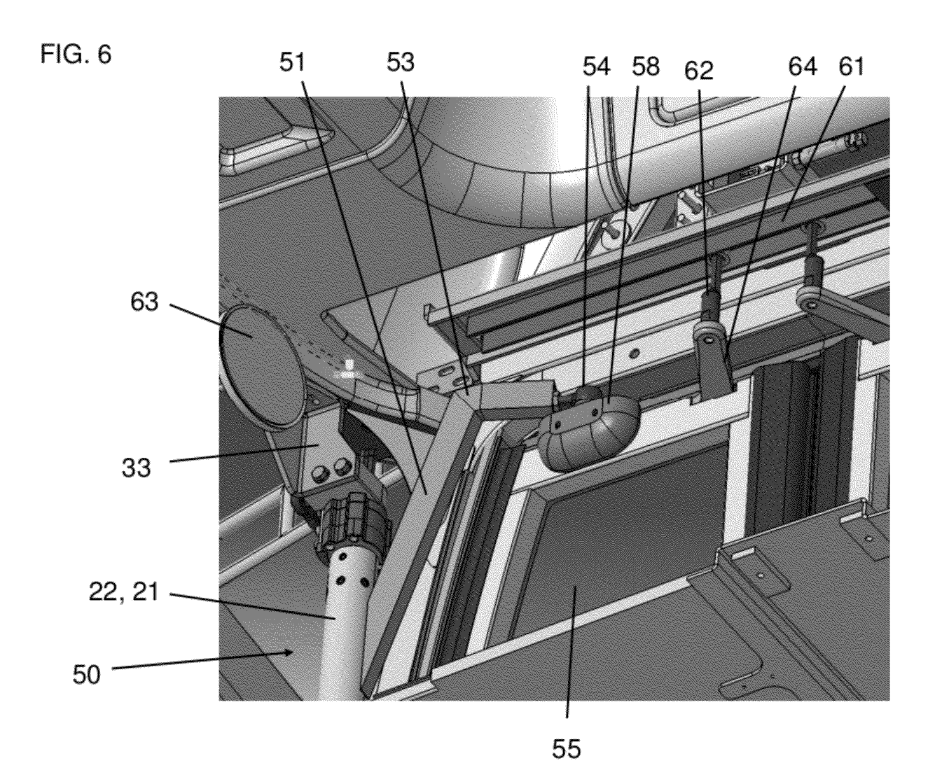

FIG. 6 shows an enlarged perspective view of the upper area from FIG. 5 viewed obliquely from below. FIG. 6 permits a closer look at the supporting component 33 with which the rotation post 21 is attached to the vehicle. Furthermore, the guide rail 61 with the laterally displaceable support of the bearing pin 62 as well as the bearing pin bracket 64 on the door leaf 55 and the support of the rotary bearing 54 on the door bearing, at the end of the supporting arm, can be seen.

FIG. 7 shows a perspective view of a lower area of the drive device 50 shown in FIG. 4 inside a vehicle. The inward-swinging door 56 is shown in FIG. 7 in a slightly opened state. As is apparent from the Figure, the rotation post 21 is connected to the vehicle at its lower end via the floor bearing 28. Thus, the drive device is rotatably attached to the vehicle only through two bearings, namely the supporting component 33 and the floor bearing 28, which offers considerable advantages both for the installation as well as for the adjustment of the drive device 50 according to the invention.

As can also be seen from FIG. 7, the front edge 59 of the door leaf 55 first swings inwards, that is, into the passenger cabin of the vehicle, during an opening process. The door leaf 55 is supported by the lower supporting arm 52. For this purpose, a rotary bearing 65 with which the door leaf 55 is rotatably supported is provided at its distal end. The supporting arm 52 in the depicted exemplary embodiment of the drive device 50 substantially extends perpendicularly to the rotation post and thus, in contrast to the upper supporting arm 51, substantially has no extension component parallel to the rotation post 21.

The same lower area from FIG. 7 is depicted in a perspective view in FIG. 8, but in this case outside of the vehicle. It can be seen clearly that the lower rotary bearing 65 shown in FIG. 7, with which the door leaf 55 is rotatably connected to the lower supporting arm 52, is protected by a flexible supporting arm cover 66 or sealing device against external influences, in particular against dirt and corrosion, e.g. by water, snow and road salt. Accordingly, the supporting arm cover 66 serves as a device for sealing the door opening towards the outside. Expediently, the supporting arm cover 66 can be made, for example, from a suitable rubber material or a flexible plastic.

Apart from the protective function, the supporting arm cover 66 moreover adds to a good visual external overall impression of the vehicle since no components, in particular components for supporting the door leaf 55, are visible from outside the vehicle. It is not until the door leaf 55 is swung in when the inward-swinging door 56 is opened that the flexible supporting arm cover 66 folds upwards, for example due a pressure exerted upon it by the supporting arm 52, so that the door leaf 55 can swing inwards above the lower supporting arm 52 without impediment.

The drive device according to the invention was explained in more detail with reference to exemplary embodiments shown in the Figures. However, the drive device is not limited to the embodiments described herein, but also includes embodiments having the same effects. For example, it is conceivable that the lower supporting arm 25 instead of the upper supporting arm 24 or additionally to the upper supporting arm 24 has an extension component parallel to the rotation post 21. In that case, the lower rotary floor bearing 28 of the rotation post 21 can also be disposed above the lower door bearing 27 or above the lower edge of the boarding/deboarding device 56 or inward-swinging door 55 supported by the supporting arm 25.

The same applies, mutatis mutandis, for the at least one crank 34 provided in the distal end portion of a supporting arm 24, 25. This can also be provided both on the upper and/or the lower supporting arm 24 or 25, respectively. Apart from the shapes shown in the exemplary embodiments, the crank 34 itself can also be configured in an arcuate manner or be formed of more than two straight portions. Also, two or more cranks can be provided in the distal end portion of a supporting arm 24, 25, wherein the cranks can also have different cranking directions.

In a preferred embodiment, the drive device according to the invention is used for driving inward-swinging doors of public transport vehicles. For this purpose, the drive device comprises a drive unit, which is disposed in a rotation post and drives it for opening and closing the inward-swinging door, wherein the drive unit is supported by a supporting component on the vehicle and the supporting component acts as a counter bearing for a torque of the drive unit. Furthermore, the drive device comprises at least two supporting arms connected to the rotation post for supporting the inward-swinging door, wherein the upper supporting arm has an extension component parallel to the rotation post. Preferably, the lower supporting arm is disposed perpendicularly and straight relative to the drive shaft. Particularly preferably, the upper supporting arm has at its distal end a crank. At the distal ends of the two supporting arms, a bearing is respectively provided for the rotatable support of the inward-swinging door.

1. Drive device for boarding/deboarding devices for public transport vehicles, comprising:
a drive unit, which is disposed in a rotation post, and configured for opening and closing the boarding/deboarding device,
wherein the drive unit is supported by a supporting component on the vehicle and the supporting component acts as a counter bearing for a torque of the drive unit,
wherein at least two supporting arms are connected to the rotation post for supporting the boarding/deboarding device and at least one supporting arm has an extension component parallel to the rotation post.

2. Drive device according to claim 1, wherein the supporting arm, which has an extension component parallel to the rotation post, moreover has at least one crank in an area of the a distal end.

3. Drive device according to claim 1, wherein the drive device is formed exclusively of substantially rigid components.

4. Drive device according to claim 1, wherein the rotation post is configured straight.

5. Drive device according to claim 1, wherein a bearing, which enables the rotation post to tumble, is provided between the drive unit and the supporting component.

6. Drive device according to claim 1, wherein a guide shaft extends from the drive unit into the bearing and comprises receptacles for receiving balls disposed in depressions of a ball receptacle of the bearing, wherein the depressions permit a movement of the balls in direction parallel to the rotation post, so that the guide shaft is mounted in the ball receptacle so as to be moveable in the direction of the rotation post via the balls, but non-rotatable about a rotation axis of the rotation post.

7. Drive device according to claim 1, wherein the rotation post is supported in a joint bearing which surrounds a ball receptacle, wherein the guide shaft and the rotation post tumble about a common tumbling point disposed on a rotation axis (Z-Z) of the rotation post.

8. Drive device according to claim 1, wherein the guide shaft is non-rotatably connected to the drive unit.

9. Drive device according to claim 1, wherein the supporting arms have at their distal ends one bearing, respectively, for rotatably supporting the boarding/deboarding device.

10. Drive device according to claim 1, wherein the boarding/deboarding device supported by the supporting arms including a sealing device is larger than the rotation post, and an upper rotary bearing of the rotation post is disposed below the upper bearing for rotatably supporting the boarding/deboarding device and/or a lower rotary floor bearing of the rotation post is disposed above the lower bearing for rotatably supporting the boarding/deboarding device.
